(19) United States
(12) Patent Application Publication
(10) Pub. No.: US 2021/0309554 A1
(43) Pub. Date: Oct. 7, 2021

(54) APPARATUS AND METHODS FOR MANUFACTURING A GLASS RIBBON

(71) Applicant: CORNING INCORPORATED, CORNING, NY (US)

(72) Inventors: Franck Olivier Hounkpevi, Painted Post, NY (US); Pierre Laronze, CORNING, NY (US); XI Xie, Painted Post, NY (US)

(21) Appl. No.: 17/269,074

(22) PCT Filed: Aug. 12, 2019
(86) PCT No.: PCT/US2019/046154

§ 371 Date: Feb. 17, 2021

Related U.S. Application Data
(60) Provisional application No. 62/720,446, filed on Aug. 21, 2018.

(51) Int. Cl. C03B 5/24; C03B 17/06; G01F 23/292

(52) U.S. Cl. CPC C03B 5/24; G01F 23/2928; C03B 17/064

(57) ABSTRACT

A glass manufacturing apparatus includes a vessel and a filter positioned to receive a beam of light. The filter passes a second wavelength component of the beam of light through the filter while preventing a first wavelength component from the beam of light from passing through the filter. The glass manufacturing apparatus comprises a sensor positioned to receive the second wavelength component that has passed through the filter and that has been reflected within the vessel. Additionally, methods of determining a level of molten material within a glass manufacturing apparatus and methods of manufacturing glass are provided.

### CROSS-REFERENCE TO RELATED APPLICATION

This application claims the benefit of priority under 35 U. S.C. § 119 of U.S. Provisional Application Ser. No. 62/720446 filed on Aug. 21, 2018, the content of which is relied upon and incorporated herein by reference in its entirety.

### BACKGROUND

It is known to measure a level of molten material during a glass manufacturing process with a level sensor. Contact between the molten material and the level sensor can introduce unwanted contaminants to the molten material. In addition, the level sensor may not be usable at certain locations due to level variations of the molten material.

### SUMMARY

The following presents a simplified summary of the disclosure to provide a basic understanding of some embodiments described in the detailed description.

The present disclosure relates generally to methods and apparatus for manufacturing a glass ribbon and, more particularly, to methods of manufacturing a glass ribbon using a glass measurement apparatus.

In some embodiments, a glass manufacturing apparatus can comprise a vessel. The glass manufacturing apparatus can comprise a filter positioned to receive a beam of light. The filter can pass a second wavelength component of the beam of light through the filter while preventing a first wavelength component from the beam of light from passing through the filter. The glass manufacturing apparatus can comprise a sensor that can receive the second wavelength component that has passed through the filter and that has been reflected within the vessel.

In some embodiments, the second wavelength component can comprise a wavelength less than a wavelength of the first wavelength component.

In some embodiments, the second wavelength component can comprise a wavelength less than about 600 nanometers and the first wavelength component can comprise a wavelength greater than about 600 nanometers.

In some embodiments, the glass manufacturing apparatus can further comprise molten material with a free surface positioned within the vessel.

In some embodiments, the sensor can be positioned to receive the second wavelength component that has been reflected from the free surface of the molten material positioned within the vessel.

In some embodiments, the glass manufacturing apparatus can further comprise a light source positioned to emit the beam of light.

In some embodiments, the glass manufacturing apparatus can further comprise a lens configured to split the beam of light into a plurality of wavelength components comprising the first wavelength component and the second wavelength component, and wherein the filter can be positioned to receive the split beam of light from the lens.

In some embodiments, the glass manufacturing apparatus can further comprise a jacket defining a jacket interior within which one or more of the filter or the sensor are positioned.

In some embodiments, the jacket can be optically transparent.

In some embodiments, methods of determining a level of molten material within a glass manufacturing apparatus can comprise reflecting a beam of light comprising a second wavelength component from a free surface of a molten material. Methods can comprise sensing the second wavelength component from the beam of light reflected from the free surface of the molten material. Methods can comprise determining a level of the molten material based on the sensed second wavelength component of the beam of light.

In some embodiments, methods of determining a level of molten material within a glass manufacturing apparatus can further comprise removing a first wavelength component from the beam of light prior to reflecting the beam of light comprising the second wavelength component.

In some embodiments, methods of determining a level of molten material within a glass manufacturing apparatus can further comprise removing a first wavelength component from the beam of light prior to reflecting the beam of light comprising the second wavelength component.

In some embodiments, prior to removing the first wavelength component from the beam of light, methods of determining a level of molten material within a glass manufacturing apparatus can further comprise splitting the beam of light into a plurality of wavelength components comprising the first wavelength component and the second wavelength component.

In some embodiments, the second wavelength component can comprise a wavelength less than a wavelength of the first wavelength component.

In some embodiments, methods of determining a level of molten material within a glass manufacturing apparatus can further comprise cooling a sensor that senses the second wavelength component.

In some embodiments, methods of determining a level of molten material within a glass manufacturing apparatus can further comprise cooling a filter that removes the first wavelength component from the beam of light.

In some embodiments, methods of determining a level of molten material within a glass manufacturing apparatus can further comprise changing a flowrate of the molten material based on the determined level of the molten material.

In some embodiments, the changing the flowrate comprises adjusting a temperature of the molten material.

In some embodiments, the changing the flowrate may be further based on a weight of a glass ribbon formed from the molten material.

In some embodiments, methods of manufacturing glass can comprise supplying a batch material to a melting vessel at a batch fill rate. Methods can comprise melting the batch material into a molten material. Methods can comprise reflecting a beam of light comprising a second wavelength component from a free surface of the molten material. Methods can comprise sensing the second wavelength component from the beam of light reflected from the free surface of the molten material. Methods can comprise changing the batch fill rate based on the sensed second wavelength component.

In some embodiments, methods of manufacturing glass can further comprise determining a level of the molten material based on the sensed second wavelength component.

In some embodiments, the changing the batch fill rate can be based on the determined level of the molten material.

In some embodiments, the second wavelength component can comprise a wavelength less than a wavelength of the first wavelength component.

In some embodiments, methods of manufacturing glass can further comprise cooling a sensor that senses the second wavelength component.

In some embodiments, methods of manufacturing glass can further comprise cooling a filter that removes the first wavelength component from the beam of light.

In some embodiments, methods of manufacturing glass can further comprise adjusting a temperature of the molten material based on the sensed second wavelength component.

In some embodiments, the changing the batch fill rate may be further based on a weight of a glass ribbon formed from the molten material.

It is to be understood that both the foregoing general description and the following detailed description present embodiments of the present disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages of the present disclosure can be further understood when read with reference to the accompanying drawings, in which:

FIG. 1 schematically illustrates an exemplary embodiment of a glass manufacturing apparatus in accordance with embodiments of the disclosure;

FIG. 2 shows a perspective cross-sectional view of the glass manufacturing apparatus along line 2-2 of FIG. 1 in accordance with embodiments of the disclosure;

FIG. 3 illustrates a schematic front view of some embodiments of a glass measurement apparatus in accordance with embodiments of the disclosure;

FIG. 4 illustrates a schematic front view of some embodiments of the glass measurement apparatus and a vessel in accordance with embodiments of the disclosure;

FIG. 5 schematically illustrates additional embodiments of the glass manufacturing apparatus in accordance with embodiments of the disclosure;

FIG. 6 schematically illustrates an exemplary embodiment of a process for changing a batch fill rate of batch material based on a determined level of molten material in accordance with embodiments of the disclosure;

FIG. 7 schematically illustrates additional embodiments of the glass manufacturing apparatus comprising a controller that can control the batch fill rate of batch material and a temperature of the molten material in accordance with embodiments of the disclosure;

FIG. 8 schematically illustrates additional embodiments of the glass manufacturing apparatus comprising a controller that can control the batch fill rate of batch material and the temperature of the molten material in accordance with embodiments of the disclosure; and

FIG. 9 schematically illustrates additional embodiments of the glass manufacturing apparatus comprising a controller that can control the batch fill rate of batch material and the temperature of the molten material in accordance with embodiments of the disclosure.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, this disclosure may be embodied in many different forms and should not be construed as limited to the embodiments set forth herein.

Apparatus and methods of the disclosure can provide glass ribbon that may be subsequently divided into glass sheets. In some embodiments, the glass sheets may be provided with four edges forming a parallelogram such as a rectangle (e.g., square), trapezoidal or other shape. In further embodiments, the glass sheets may be a round, oblong, or elliptical glass sheet with one continuous edge. Other glass sheets comprising two, three, five, etc. curved and/or straight edges may also be provided and are contemplated as being within the scope of the present description. Glass sheets of various sizes, including varying lengths, heights, and thicknesses, are also contemplated. In some embodiments, an average thickness of the glass sheets can be various average thicknesses between oppositely facing major surfaces of the glass sheet. In some embodiments, the average thickness of the glass sheet can be greater than 50 micrometers (μm), such as from about 50 μm to about 1 millimeter (mm), such as from about 100 μm to about 300 μm although other thicknesses may be provided in further embodiments. Glass sheets can be used in a wide range of display applications such as, but not limited to, liquid crystal displays (LCDs), electrophoretic displays (EPD), organic light emitting diode displays (OLEDs), and plasma display panels (PDPs).

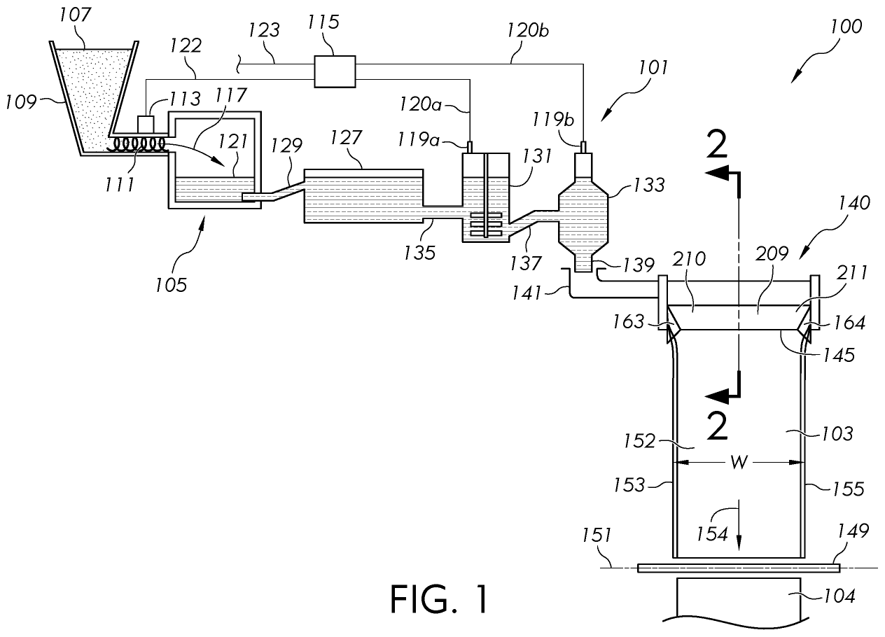

As schematically illustrated in FIG. 1, in some embodiments, an exemplary glass manufacturing apparatus 100 can comprise a glass forming apparatus 101 comprising a forming vessel 140 designed to produce a glass ribbon 103 from a quantity of molten material 121. In some embodiments, the glass ribbon 103 can comprise a central portion 152 disposed between opposite, relatively thick edge beads formed along a first lateral edge 153 and a second lateral edge 155 of the glass ribbon 103. Additionally, in some embodiments, a glass sheet 104 can be separated from the glass ribbon 103 along a separation path 151 by a glass separator 149 (e.g., scribe, score wheel, diamond tip, laser, etc.). In some embodiments, before or after separation of the glass ribbon 103 with the glass separator 149, the relatively thick edge beads formed along the first lateral edge 153 and the second lateral edge 155 can be removed to provide the central portion 152 as a high-quality glass ribbon 103 comprising a uniform thickness.

In some embodiments, the glass manufacturing apparatus 100 can comprise a melting vessel 105 oriented to receive batch material 107 from a storage bin 109. The batch material 107 can be introduced by a batch delivery device 111 powered by a motor 113. In some embodiments, methods of manufacturing glass may comprise supplying the batch material 107 to the melting vessel 105 at a batch fill rate. In some embodiments, a controller 115 can be operated to activate the motor 113 to introduce a desired amount of batch material 107 into the melting vessel 105, as indicated by arrow 117. The melting vessel 105 can heat the batch material 107 to provide molten material 121. Methods of manufacturing glass may comprise melting the batch material 107 into the molten material 121.

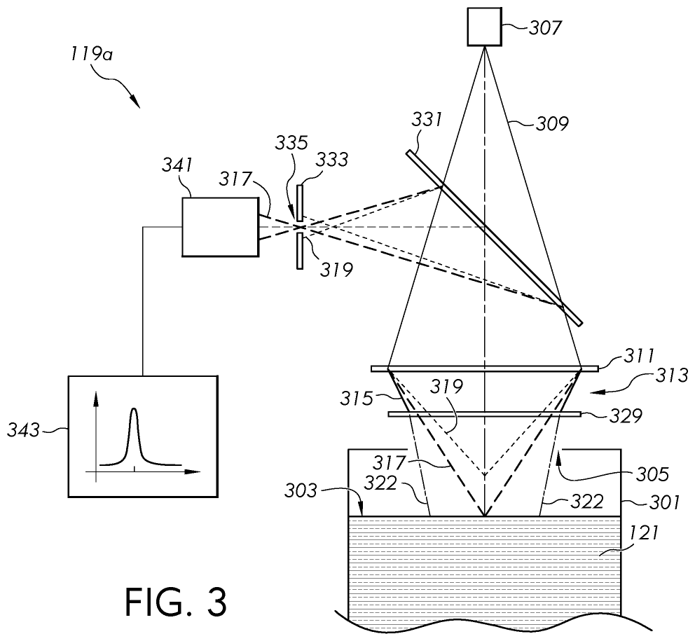

In some embodiments, a glass measurement apparatus 119a, 119b can be employed to measure a level of the molten material 121 within a vessel (e.g., a fining vessel 127, a mixing chamber 131, a delivery vessel 133, one or more connecting conduits 135, 137, etc.) and communicate the measured information to the controller 115 by way of a communication line 120a, 120b. Based on the level of the molten material 121 measured by the glass measurement apparatus 119a, 119b, the controller 115 can change the batch fill rate, such as by adjusting a speed of the motor 113. For example, the controller 115 can receive a level by way of level communication lines 120a, 120b from the glass measurement apparatus 119a, 119b that measures the level of the molten material 121 within the vessel 301 (see FIG. 3). In some embodiments, a predetermined level setpoint 123 can be provided to the controller 115 for controlling a level of the molten material 121. Based on the difference between the predetermined level setpoint 123 and the glass level provided to the controller 115 by the level communication lines 120a, 120b, the controller 115 can adjust a speed command to the motor 113 by way of a speed command line 122. The motor 113 can then adjust the speed of the batch delivery device 111 to increase or decrease the batch fill rate of the batch material 107 to the melting vessel 105.

Additionally, in some embodiments, the glass manufacturing apparatus 100 can comprise a first conditioning station comprising the fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass manufacturing apparatus 100 can further comprise a second conditioning station comprising the mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 through an interior pathway of the second connecting conduit 135 from the fining vessel 127 to the mixing chamber 131.

Additionally, in some embodiments, the glass manufacturing apparatus 100 can comprise a third conditioning station comprising the delivery vessel 133 that can be located downstream from the mixing chamber 131. In some embodiments, the delivery vessel 133 can condition the molten material 121 to be fed into an inlet conduit 141 of the forming vessel 140. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 through an interior pathway of the third connecting conduit 137 from the mixing chamber 131 to the delivery vessel 133. As further illustrated, in some embodiments, a delivery pipe 139 (e.g., downcomer) can be positioned to deliver molten material 121 to the inlet conduit 141.

Various embodiments of forming vessels can be provided in accordance with features of the disclosure comprising a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the forming vessel 140 shown and disclosed below can be provided to fusion draw molten material 121 off a root 145 of a forming wedge 209 to produce the glass ribbon 103. For example, in some embodiments, the molten material 121 can be delivered from the inlet conduit 141 to the forming vessel 140. The molten material 121 can then be formed into the glass ribbon 103 based in part on the structure of the forming vessel 140. For example, as shown, the molten material 121 can be drawn off the bottom edge (e.g., root 145) of the forming vessel 140 along a draw path extending in a glass ribbon travel direction 154 of the glass manufacturing apparatus 100. In some embodiments, edge directors 163, 164 can direct the molten material 121 off the forming vessel 140 and define, in part, a width “W” of the glass ribbon 103. In some embodiments, the width “W” of the glass ribbon 103 can extend between the first lateral edge 153 of the glass ribbon 103 and the second lateral edge 155 of the glass ribbon 103.

In some embodiments, the width “W” of the glass ribbon 103 can be greater than or equal to about 20 mm, such as greater than or equal to about 50 mm, such as greater than or equal to about 100 mm, such as greater than or equal to about 500 mm, such as greater than or equal to about 1000 mm, such as greater than or equal to about 2000 mm, such as greater than or equal to about 3000 mm, such as greater than or equal to about 4000 mm, although other widths less than or greater than the widths mentioned above can be provided in further embodiments. For example, in some embodiments, the width “W” of the glass ribbon 103 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

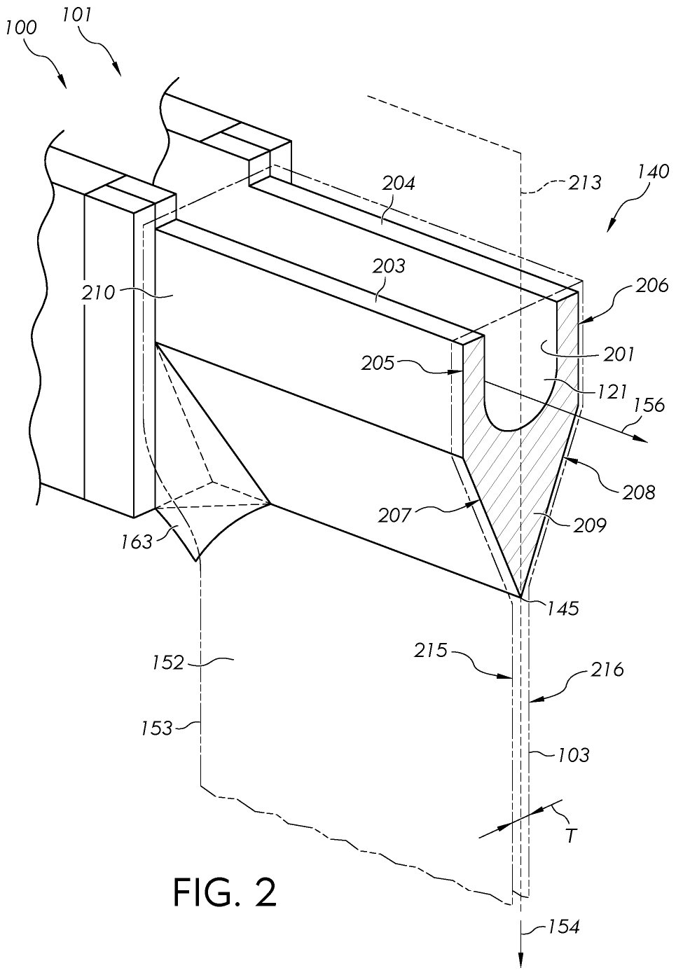

FIG. 2 shows a cross-sectional perspective view of the glass manufacturing apparatus 100 along line 2-2 of FIG. 1. In some embodiments, the forming vessel 140 can comprise a trough 201 oriented to receive the molten material 121 from the inlet conduit 141. For illustrative purposes, cross-hatching of the molten material 121 is removed from FIG. 2 for clarity. The forming vessel 140 can further comprise the forming wedge 209 comprising a pair of downwardly inclined converging surface portions 207, 208 extending between opposed ends 210, 211 (See FIG. 1) of the forming wedge 209. The pair of downwardly inclined converging surface portions 207, 208 of the forming wedge 209 can converge along the glass ribbon travel direction 154 to intersect along a bottom edge of the forming wedge 209 to define the root 145 of the forming vessel 140. A draw plane 213 of the glass manufacturing apparatus 100 can extend through the root 145 along the glass ribbon travel direction 154. In some embodiments, the glass ribbon 103 can be drawn in the glass ribbon travel direction 154 along the draw plane 213. As shown, the draw plane 213 can bisect the forming wedge 209 through the root 145 although, in some embodiments, the draw plane 213 can extend at other orientations relative to the root 145.

Additionally, in some embodiments, the molten material 121 can flow in a direction 156 into the trough 201 of the forming vessel 140. The molten material 121 can then overflow from the trough 201 by simultaneously flowing over corresponding weirs 203, 204 and downward over the outer surfaces 205, 206 of the corresponding weirs 203, 204. Respective streams of molten material 121 can then flow along the downwardly inclined converging surface portions 207, 208 of the forming wedge 209 to be drawn off the root 145 of the forming vessel 140, where the flows converge and fuse into the glass ribbon 103. The glass ribbon 103 can then be fusion drawn off the root 145 in the draw plane 213 along the glass ribbon travel direction 154. In some embodiments, the glass separator 149 (see FIG. 1) can then subsequently separate a portion of the glass ribbon 103 along the separation path 151. For example, as shown in FIG. 1, a portion of a glass ribbon 103 in the form of a glass sheet 104 can be separated from the glass ribbon 103 along the separation path 151. As illustrated, in some embodiments, the separation path 151 can extend along the width “W” of the glass ribbon 103 between the first lateral edge 153 and the second lateral edge 155. Additionally, in some embodiments, the separation path 151 can extend perpendicular to the glass ribbon travel direction 154 of the glass ribbon 103. Moreover, in some embodiments, the glass ribbon travel direction 154 can define a direction along which the glass ribbon 103 can be fusion drawn from the forming vessel 140. In some embodiments, the glass ribbon 103 can include a speed as it traverses along the glass ribbon travel direction 154 of ≥50 mm/s, ≥100 mm/s, or >500 mm/s, for example, from about 50 mm/s to about 500 mm/s, such as from about 100 mm/s to about 500 mm/s, and all ranges and subranges therebetween.

As shown in FIG. 2, the glass ribbon 103 can be drawn from the root 145 with a first major surface 215 of the glass ribbon 103 and a second major surface 216 of the glass ribbon 103 facing opposite directions and defining a thickness “T” (e.g., average thickness) of the glass ribbon 103. In some embodiments, the thickness “T” of the glass ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness “T” of the glass ribbon 103 can be from about 50 μm to about 750 μm, from about 100 μm to about 700 μm, from about 200 μm to about 600 μm, from about 300 μm to about 500 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, from about 50 μm to about 100 μm, including all ranges and subranges of thicknesses therebetween. In addition, the glass ribbon 103 can comprise a variety of compositions comprising, but not limited to, soda-lime glass, borosilicate glass, alumino-borosilicate glass, alkali-containing glass, or alkali-free glass.

Referring to FIG. 3, in some embodiments, the glass measurement apparatus 119a can be positioned in proximity to a vessel 301. It will be appreciated that the vessel 301 is illustrated schematically in FIG. 3 as the vessel 301 can comprise several different structures of the glass manufacturing apparatus 100. For example, the vessel 301 may comprise one or more of the fining vessel 127, the first connecting conduit 129, the mixing chamber 131, the delivery vessel 133, the second connecting conduit 135, the third connecting conduit 137, etc. In some embodiments, the glass manufacturing apparatus 100 can comprise the molten material 121 with a free surface 303 positioned within the vessel 301. The free surface 303 may comprise an uppermost level of the molten material 121 above which there may be an atmosphere that interfaces with the free surface 303. The vessel 301 can comprise a vessel wall that can define a vessel opening 305 through which the glass measurement apparatus 119a can measure the level of the molten material 121.

While FIG. 3 illustrates one glass measurement apparatus 119a, other glass measurement apparatus (e.g., glass measurement apparatus 119b) can be substantially similar in structure and function. For example, a plurality of glass measurement apparatus 119a, 119b can be provided within the glass manufacturing apparatus 100 to measure a level of the molten material 121 within one or more vessels 301. Referring briefly to FIG. 1, one glass measurement apparatus 119a can be attached to the mixing chamber 131, while another glass measurement apparatus 119b can be attached to the delivery vessel 133. A level of the molten material 121 can therefore be measured at a plurality of locations within the glass manufacturing apparatus 100 by the glass measurement apparatus 119a, 119b.

The glass measurement apparatus 119a can comprise a light source 307 that can be oriented to face the vessel 301, such as by facing the vessel opening 305. In some embodiments, the light source 307 can be positioned to emit a beam of light 309 towards the vessel 301 and through the vessel opening 305. For example, the beam of light 309 may comprise a white light, and can pass through the vessel opening 305 of the vessel 301, whereupon the beam of light 309 can be reflected from the free surface 303 of the molten material 121.

The glass measurement apparatus 119a can comprise a lens 311. In some embodiments, the lens 311 can be positioned to receive the beam of light 309 from the light source 307. The lens 311 may be positioned between the light source 307 and the vessel 301, for example, between the light source 307 and the vessel opening 305. In some embodiments, the lens 311 splits the beam of light 309 into a plurality of wavelength components 313, which can comprise a first wavelength component 315 and a second wavelength component 317. The plurality of wavelength components 313 can comprise other, additional, wavelength components, such as a third wavelength component 319, etc. The plurality of wavelength components 313 can comprise spectral wavelength components of the beam of light 309, such as a red spectral wavelength component, a green spectral wavelength component, a blue spectral wavelength component, etc. In some embodiments, the red spectral wavelength component may be represented by the first wavelength component 315, the green spectral wavelength component may be represented by the second wavelength component 317, and the blue spectral wavelength component may be represented by the third wavelength component 319. The plurality of wavelength components 313 can converge at a focal point located a focal length from the lens 311.

In some embodiments, the different wavelength components (e.g., the first wavelength component 315, the second wavelength component 317, the third wavelength component 319, etc.) can have differing focal lengths as measured from the lens 311. The differing focal lengths may be based on the differing wavelengths of the first wavelength component 315, the second wavelength component 317, and the third wavelength component 319. For example, the second wavelength component 317 can comprise a wavelength less than a wavelength of the first wavelength component 315. The third wavelength component 319 can comprise a wavelength less than a wavelength of the first wavelength component 315 and the second wavelength component 317. In some embodiments, the second wavelength component 317 can comprise a wavelength less than about 600 nanometers (nm) and the first wavelength component 315 can comprise a wavelength greater than about 600 nm. Wavelength components that comprise shorter wavelengths can have shorter focal lengths and thereby focus a closer distance from the lens. Wavelength components that comprise longer wavelengths can have longer focal lengths and thereby focus a farther distance from the lens. For example, the first wavelength component 315 (e.g., the red spectral wavelength component comprising the longest wavelength) may have the longest focal length. The second wavelength component 317 (e.g., the green spectral wavelength component comprising a wavelength that can be less than the red spectral wavelength component but greater than the blue spectral wavelength component) may have a focal length shorter than a focal length of the first wavelength component 315 but longer than a focal length of the third wavelength component 319. The third wavelength component 319 (e.g., the blue spectral wavelength component comprising the shortest wavelength) may have a focal length shorter than a focal length of the first wavelength component 315 and a focal length of the second wavelength component 317. In some embodiments, the first wavelength component 315 can have a focal length longer than the second wavelength component 317, and the second wavelength component 317 can have a focal length longer than the third wavelength component 319.

The glass measurement apparatus 119a can comprise a filter 329. In some embodiments, the filter 329 can be positioned to receive the beam of light 309. For example, the filter 329 may be positioned to receive the split beam of light (e.g., comprising the plurality of wavelength components 313) from the lens 311. The filter 329 may be positioned between the lens 311 and the vessel 301, such as between the lens 311 and the vessel opening 305. In some embodiments, the filter 329 can pass one or more of the wavelength components of the beam of light 309 through the filter 329 while preventing one or more other wavelength components of the beam of light 309 from passing through the filter 329. For example, the filter 329 can pass the second wavelength component 317 of the beam of light 309 through the filter 329 while preventing the first wavelength component 315 from the beam of light from passing through the filter 329. In this way, the filter 329 can prevent wavelength components comprising a certain wavelength from passing through while allowing wavelength components comprising another wavelength to pass through. For example, the filter 329 can allow the second wavelength component 317 (e.g., the green spectral wavelength component) and the third wavelength component 319 (e.g., the blue spectral wavelength component) to pass through while preventing the first wavelength component 315 (e.g., the red spectral wavelength component) from passing through. In some embodiments, methods of determining a level of the molten material 121 within the glass manufacturing apparatus 100 can comprise, prior to removing the first wavelength component 315 from the beam of light 309, splitting the beam of light 309 into the plurality of wavelength components 313 comprising the first wavelength component 315 and the second wavelength component 317 and the third wavelength component 319.

In some embodiments, the beam of light 309, comprising the second wavelength component 317 and the third wavelength component 319, can pass through the vessel opening 305 and be reflected from the free surface 303 of the molten material 121. In some embodiments, methods of determining a level of the molten material 121 within the glass manufacturing apparatus 100 can comprise reflecting the beam of light 309 comprising the second wavelength component 317 from the free surface 303 of the molten material 121. For example, in some embodiments, a focal length of one of the wavelength components (e.g., the second wavelength component 317, the third wavelength component 319, etc.) can substantially match a distance between the free surface 303 of the molten material 121 and the filter 329. For example, as illustrated in FIG. 3, a focal length of the second wavelength component 317 can substantially match the distance between the free surface 303 and the filter 329. However, the free surface 303 may not be limited to such a level within the vessel 301. Rather, in other embodiments, the free surface 303 can be located a different distance from the filter 329, such that a focal length of another one of the wavelength components (e.g., the third wavelength component 319, for example) can substantially match the distance between the free surface 303 and the filter 329. By substantially matching, the focal length of one of the wavelength components (e.g., the second wavelength component 317, the third wavelength component 319, etc.) can be close to the distance between the free surface 303 of the molten material 121 and the filter 329 while not being identical, and may be closer to this distance than the other wavelength components.

In some embodiments, the wavelength components (e.g., the second wavelength component 317, the third wavelength component 319, etc.) of the beam of light 309 reflected from the free surface 303 travel along a reverse path through the filter 329 and through the lens 311. In some embodiments, the molten material 121 can emit an emitted wavelength component 322, such as a red spectral wavelength component (e.g., comprising the same wavelength as first wavelength component 315), for example. The emitted wavelength component 322 can generate noise and adversely affect the glass measurement apparatus 119a from detecting the level of the molten material 121. To reduce these effects, the filter 329 can prevent the emitted wavelength component 322 emitted by the molten material 121 from passing through the filter 329. In some embodiments, methods of determining a level of the molten material 121 within the glass manufacturing apparatus 100 can comprise removing the first wavelength component 315 from the beam of light 309 prior to reflecting the beam of light 309 comprising the second wavelength component 317. In this way, the filter 329 can prevent the first wavelength component 315 and the emitted wavelength component 322 from passing through the filter 329 in both directions (e.g., the first wavelength component 315 heading towards (e.g., downwards in FIG. 3) the free surface 303 and the emitted wavelength component 322 heading away (e.g., upwards in FIG. 3) from the free surface 303).

The glass measurement apparatus 119a can comprise a beamsplitter 331. In some embodiments, the beamsplitter 331 can be positioned to receive the beam of light 309 comprising the second wavelength component 317 and the third wavelength component 319. For example, the beamsplitter 331 may be positioned to receive the beam of light 309 (e.g., comprising the second wavelength component 317 and the third wavelength component 319) from the lens 311. The beamsplitter 331 may be positioned between the lens 311 and the light source 307. In some embodiments, after the beam of light 309 has been reflected from the free surface 303 of the molten material 121, the beam of light 309 can travel along a reverse path through the filter 329 followed by the lens 311. After passing through the lens 311 towards the light source 307, the beam of light 309 may be reflected by the beamsplitter 331, which can be positioned within the path of the beam of light 309 between the lens 311 and the light source 307. In some embodiments, the beamsplitter 331 can reflect the beam of light 309 towards a location away from the light source 307.

The glass measurement apparatus 119a can comprise a diffraction grating 333. The diffraction grating 333 can be positioned to receive the beam of light 309 (e.g., comprising the second wavelength component 317 and the third wavelength component 319) from the beamsplitter 331. In some embodiments, the diffraction grating 333 can define an aperture 335 (e.g., a hole, a slit, etc.) through which one of the wavelength components (e.g., the second wavelength component 317, the third wavelength component 319, etc.) can be received. In some embodiments, the diffraction grating 333 can be spaced a distance away from the beamsplitter 331, such that the wavelength components (e.g., the second wavelength component 317, the third wavelength component 319, etc.) can focus towards the diffraction grating 333. One of the wavelength components (e.g., the second wavelength component 317, for example) can have a focal length that similar to the distance between the diffraction grating 333 and the beamsplitter 331, such that the one wavelength component (e.g., the second wavelength component 317, for example) can pass through the aperture 335. The other wavelength component(s) (e.g., the third wavelength component 319, for example) can have a focal length different than the distance between the diffraction grating 333 and the beamsplitter 331, such that the other wavelength component(s) (e.g., the third wavelength component 319, for example) do not pass through the aperture 335.

The glass measurement apparatus 119a can comprise a sensor 341 that can be positioned to receive one of the wavelength components (e.g., the second wavelength component 317, the third wavelength component 319, etc.) from the beamsplitter 331. In some embodiments, the sensor 341 can be positioned to receive the second wavelength component 317 that has passed through the filter 329 and that has been reflected within the vessel 301. In some embodiments, the sensor 341 may be positioned to receive the second wavelength component 317 that has been reflected from the free surface 303 of the molten material 121 positioned within the vessel 301. In some embodiments, methods of determining a level of the molten material 121 within the glass manufacturing apparatus 100 can comprise sensing the second wavelength component 317 from the beam of light 309 reflected from the free surface 303 of the molten material 121. The sensor 341 may comprise a color detection sensor that can detect a color spectrum of the wavelength component (e.g., the second wavelength component 317, for example) received by the sensor 341.

In some embodiments, methods of determining a level of the molten material 121 within the glass manufacturing apparatus 100 can comprise determining the level of the molten material 121 based on the sensed second wavelength component 317 of the beam of light 309. For example, the glass measurement apparatus 119a can comprise a signal processor 343 that can be coupled to the sensor 341. In some embodiments, by being coupled to the sensor 341, the signal processor 343 can receive data from the sensor 341, for example, data related to the wavelength component received by the sensor 341. In some embodiments, the signal processor 343 can determine, based on the wavelength and/or color of the second wavelength component 317 received by the sensor 341, the distance between the free surface 303 of the molten material 121 and the lens 311. For example, a wavelength of the wavelength component received by the sensor 341 may be at a higher power than the other wavelengths that have been blocked by the diffraction grating 333. In some embodiments, this wavelength received by the sensor 341 (e.g., corresponding to the second wavelength component 317 in FIG. 3), can be illustrated on a graph as a wavelength at peak power while the other wavelengths corresponding to the other wavelength components (e.g., the third wavelength component 319) blocked by the diffraction grating 333 may be at a lower power. This wavelength received by the sensor 341 can correspond to the distance between the free surface 303 of the molten material 121 and the lens 311.

In some embodiments, one or more parameters within the glass manufacturing apparatus 100 can be changed based on the level of the molten material 121. For example, methods of manufacturing glass can comprise changing the batch fill rate based on the sensed second wavelength component 317. The sensed second wavelength component 317 can be received by the signal processor 343 and analyzed to determine the wavelength of the sensed second wavelength component 317. This wavelength may correspond to the distance between the free surface 303 of the molten material 121 and the lens 311, which may be indicative of the level of the molten material 121. In some embodiments, the changing the batch fill rate may be based on the determined level of the molten material 121.

Since the glass measurement apparatus 119a is configured to not contact the molten material 121, the glass measurement apparatus 119a can be used in several different vessels unsuitable for a level measurement apparatus that contacts the molten material 121. For example, the glass measurement apparatus 119a may be used to measure the level of the molten material 121 within the mixing chamber 131 and/or the delivery vessel 133. Due to variations in the level of the molten material 121 within the mixing chamber 131 and/or the delivery vessel 133, contact level measurement apparatus may be undesirable due to the fluctuating levels. In addition, a contact level measurement apparatus may introduce unwanted contaminants to the molten material 121 due to the contact between the level measurement apparatus and the molten material 121. A non-contact level measurement apparatus 119a can minimize these drawbacks.

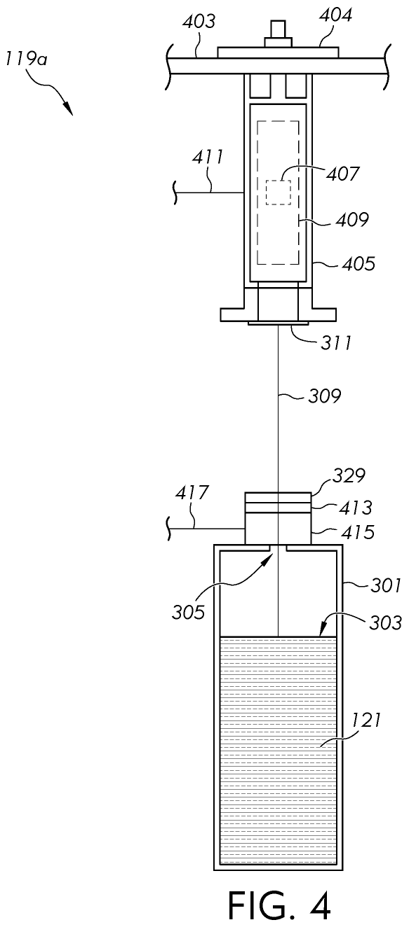

Referring to FIG. 4, a side view of the glass measurement apparatus 119a in association with the vessel 301 is illustrated. It will be appreciated that the vessel 301 is illustrated schematically, as the vessel 301 may comprise several different structures within the glass manufacturing apparatus 100, for example, the fining vessel 127, a mixing chamber 131, the delivery vessel 133, one or more connecting conduits 135, 137, etc. In some embodiments, the glass measurement apparatus 119a can be attached to a wall 403. For example, a mounting assembly 404 can be attached to a side of the wall 403 with one or more fasteners (e.g., screws, bolts, etc.). In some embodiments, the glass measurement apparatus 119a can comprise a jacket 405 that may be attached to the wall 403. The jacket 405 can be attached to the mounting assembly 404 (e.g., such as via one or more mechanical fasteners), with the jacket 405 positioned on a first side of the wall 403, and the mounting assembly 404 positioned on an opposing second side of the wall 403. The mounting assembly 404 can maintain the jacket 405 in a fixed position relative to the wall 403, such that the jacket 405 can be limited from unintended movement relative to the wall 403.

In some embodiments, the jacket 405 can be substantially hollow to receive one or more wavelength components 407 within a jacket interior 409 (e.g., illustrated with dashed lines in FIG. 4) of the jacket 405. For example, it will be appreciated that the one or more wavelength components 407 are illustrated schematically in FIG. 4, as the wavelength components 407 may comprise several different wavelength components of the glass measurement apparatus 119a, 119b. In some embodiments, the one or more wavelength components 407 may comprise the light source 307, the lens 311, the filter 329, the beamsplitter 331, the diffraction grating 333, the sensor 341, etc. In some embodiments, the jacket 405 can define the jacket interior 409 within which one or more of the filter 329 or the sensor 341 may be positioned. The jacket 405 may be optically transparent such that the beam of light 309 can be transmitted through the jacket 405. For example, the jacket interior 409 may be substantially hollow, such that the beam of light 309 can be transmitted through the jacket interior 409 and directed towards the vessel 301. In some embodiments, the lens 311 can be attached at an end of the jacket 405 within the path of the beam of light 309, such that as the beam of light 309 exits the jacket interior 409, the beam of light 309 passes through the lens 311. As such, in some embodiments, by being optically transparent, the jacket 405 can allow for the beam of light 309 to be transmitted through the jacket interior 409 (e.g., which may be substantially hollow) and through the lens 311 to an exterior of the jacket 405.

In some embodiments, due to elevated temperatures that the jacket 405 may be subjected to near the vessel 301, the jacket 405 may be cooled to protect the wavelength components 407 within the jacket interior 409. For example, the jacket 405 may comprise a cooling line 411 that can cool the jacket 405. The cooling line 411 can deliver a cooled substance, for example a liquid, a gas, etc. to reduce a temperature within the jacket interior 409 of the jacket 405. In some embodiments, the jacket 405 may comprise an insulating material surrounding the jacket interior 409, such that a reduced temperature within the jacket interior 409 can be maintained. The jacket 405 may comprise one or more substantially hollow channels through which the cooled substance (e.g., liquid, gas, etc.) can flow. The one or more channels within the jacket 405 can be in fluid communication with the cooling line 411, such that the cooled substance can be delivered to and from the channels via the cooling line 411. In some embodiments, methods of determining the level of the molten material 121 within the glass manufacturing apparatus 100 can comprise cooling the sensor 341 that senses the second wavelength component 317. For example, with the sensor 341 positioned within the jacket interior 409, the cooling line 411 can deliver the cooled substance to cool the sensor 341. In addition, in some embodiments, the jacket 405 may be spaced a distance apart from the vessel opening 305 of the vessel 301. Such a spacing can reduce the influence of the high temperature from within the vessel 301 on the jacket 405 and the sensor 341.

In some embodiments, the filter 329 can be positioned a distance away from the jacket 405 and the lens 311. For example, a distance separating the filter 329 and the vessel 301 may be less than a distance separating the filter 329 and the lens 311. Such a position is not intended to be limiting, however, and in some embodiments, the filter 329 can be positioned proximate the lens 311, for example by being positioned adjacent to the lens or within the jacket interior 409 with the lens 311. In some embodiments, due to the filter 329 being proximate the vessel opening 305 of the vessel 301, the filter 329 may be exposed to high temperatures from within the vessel 301. In some embodiments, methods of determining the level of the molten material 121 within the glass manufacturing apparatus 100 can comprise cooling the filter 329 that can remove the first wavelength component 315 from the beam of light 309 and the emitted wavelength component from the molten material 121. For example, to reduce the effects of the high temperature on the filter 329, the glass measurement apparatus 119a may comprise a heat shield 413 to cool the filter 329. The heat shield 413 may comprise an optically transparent structure, for example a glass material, such that the beam of light 309 can pass through the filter 329 and the heat shield 413. In some embodiments, the heat shield 413 can be positioned adjacent to and in contact with the filter 329. For example, the heat shield 413 can be positioned between the filter 329 and the vessel 301. The heat shield 413 can withstand higher temperatures than the filter 329, such that the heat shield 413 can be positioned proximate the vessel opening 305 than the filter 329. The heat shield 413 can shield and/or cool the filter 329 from the high temperatures, gases, and/or contaminants generated within the vessel 301 by the molten material 121.

In some embodiments, the glass measurement apparatus 119a can comprise an air purge 415. The air purge 415 can be positioned adjacent to and in contact with the heat shield 413. For example, the air purge 415 can be positioned proximate the vessel 301 than the heat shield 413, with the air purge 415 positioned between the vessel 301 on one side and the heat shield 413 on an opposing side. In some embodiments, one side of the air purge 415 may be attached to the vessel 301 while an opposing side may be attached to the heat shield 413. Due to the gases and contaminants that may be generated by the molten material 121 within the vessel 301, the air purge 415 can maintain the optical transparency of the heat shield 413 such that the beam of light 309 can pass through the heat shield 413. For example, the air purge 415 may be substantially hollow and can define an interior through which the beam of light 309 can pass. A purge line 417 can deliver a gas (e.g., air, etc.) to and/or from the interior of the air purge 415. The delivery of this gas by the purge line 417 can maintain the heat shield 413 substantially clear of contamination from the vessel 301.

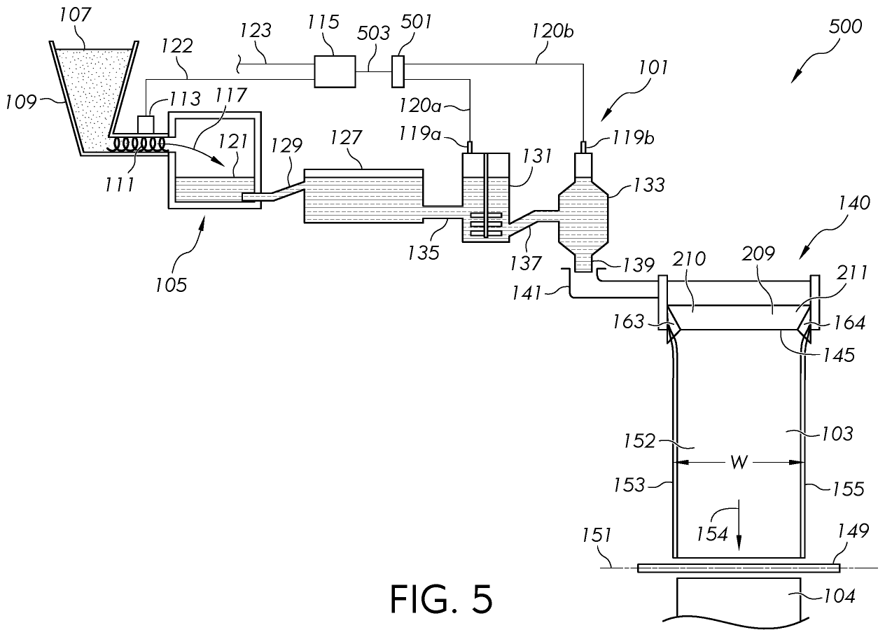

Referring to FIGS. 5-9, further embodiments of methods of determining the level of the molten material 121 within the glass manufacturing apparatus 100 and methods of manufacturing glass are illustrated. FIG. 5 illustrates further embodiments of a glass manufacturing apparatus 500. The glass manufacturing apparatus 500 may be similar in some respects to the glass manufacturing apparatus 100 of FIG. 1. For example, the glass manufacturing apparatus 500 can comprise the glass measurement apparatus 119a, 119b, the level communication lines 120a, 120b, the controller 115, etc.

The glass measurement apparatus 119a, 119b can determine the level of the molten material 121 in a similar manner as described in FIGS. 3-4. In some embodiments, the level of the molten material 121 can be transmitted from the glass measurement apparatus 119a, 119b to an operator 501. The operator 501 can receive multiple level measurements from different vessels 301 within the glass measurement apparatus 119a, 119b. In the embodiments of FIG. 5, one glass measurement apparatus 119a can measure a level of the molten material 121 at the mixing chamber 131 while a second glass measurement apparatus 119b can measure a level of the molten material 121 at the delivery vessel 133. In other embodiments, additional glass measurement apparatus may be provided, for example, at the fining vessel 127, at the connecting conduits 135, 137, etc.

In some embodiments, the operator 501 can be connected to the level communication lines 120a, 120b, such that the operator 501 can receive the level measurements from the glass measurement apparatus 119a, 119b. The operator 501 can output a single level value via a level communication line 503. In some embodiments, the operator 501 can comprise a dimension reduction linear or non-linear operator. For example, it may be desired to control a differential level between two locations (e.g., corresponding to the locations of the glass measurement apparatus 119a, 119b), such that the operator 501 can output a value representing a difference between the two levels. The controller 115 can receive the single level value from the operator 501 via the communication line 503. In some embodiments, the controller 115 can compare the predetermined level setpoint 123 and the level provided to the controller by the operator 501. If these level values differ, the controller 115 can adjust the speed command to the motor 113, whereupon the motor 113 can then adjust the speed of the batch delivery device 111, thus changing the batch fill rate. In some embodiments, the controller 115 may implement a model predictive control (MPC), an optical control method (e.g., H-infinity control), etc.

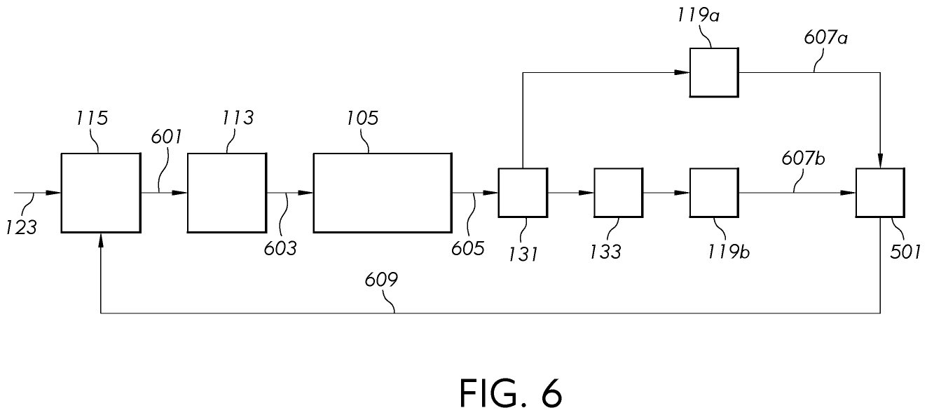

Referring to FIG. 6, a schematic flow diagram illustrating methods of manufacturing glass and methods of determining the level of molten material 121 within the glass manufacturing apparatus 100 is illustrated. In some embodiments, the controller 115 can receive the predetermined level setpoint 123. Based on the predetermined level setpoint 123, the controller 115 can calculate a speed command 601 (e.g., transmitted along the speed command line 122 of FIG. 5) for operating the motor 113. The batch material 107 can be introduced into the melting vessel 105 at a batch fill rate 603. The molten material 121 can flow from the melting vessel 105 and through the glass manufacturing apparatus 100 at a flowrate 605. For example, the molten material 121 can flow to the mixing chamber 131 and the delivery vessel 133.

In some embodiments, methods of manufacturing glass can comprise changing the batch fill rate 603 based on the sensed second wavelength component 317. For example, as described relative to FIGS. 3-4, the sensor 341 can receive the second wavelength component 317, and the signal processor 343 can determine the level of the molten material 121 within the vessel 301 based on the sensed second wavelength component 317. The level 607a, 607b can therefore be determined by the glass measurement apparatus 119a, 119b that is coupled to the mixing chamber 131 and the delivery vessel 133, whereupon the level 607a, 607b can be transmitted to the operator 501 (e.g., along the level communication lines 120a, 120b). In some embodiments, the operator 501 can transmit a level 609 to the controller 115 based on the levels 607a, 607b received from the glass measurement apparatus 119a, 119b. As described relative to FIG. 5, in some embodiments, this level 609 can comprise a differential level between the two levels 607a, 607b at the mixing chamber 131 and the delivery vessel 133. The controller 115 can compare the level 609 and the predetermined level setpoint 123, and adjust the speed command 601. For example, if the level 609 is lower than desired, the speed command 601 can be increased, which increases the batch fill rate 603. If the level 609 is higher than desired, the speed command 601 can be reduced, which decreases the batch fill rate 603. As such, in some embodiments, the changing the batch fill rate 603 may be based on the level of the molten material 121.

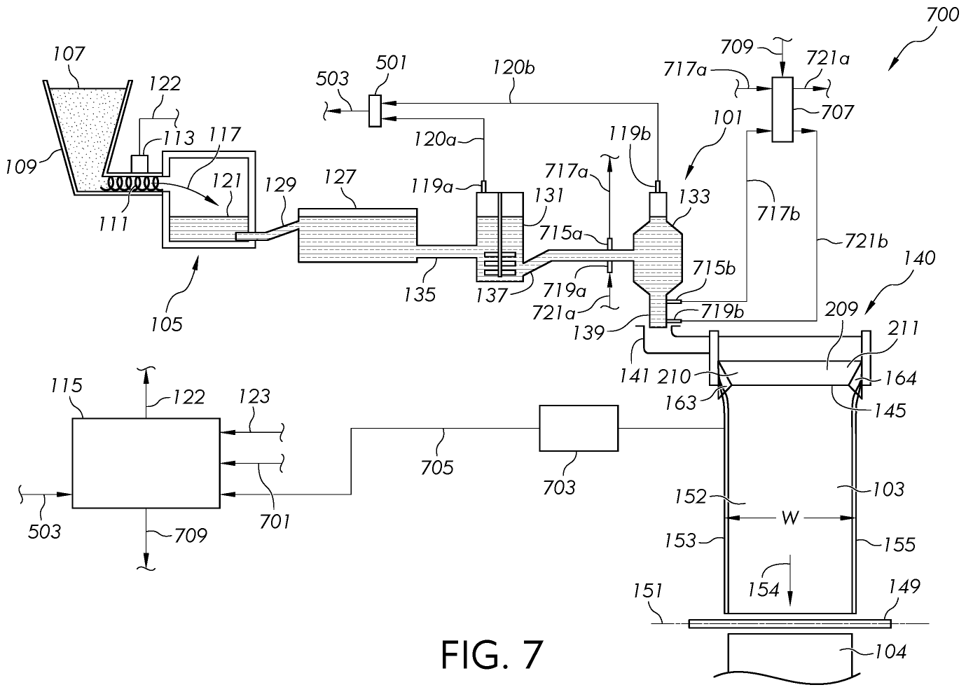

Referring to FIG. 7, further embodiments of a glass manufacturing apparatus 700 are illustrated. The glass manufacturing apparatus 700 can be similar in some respects to one or more of the glass manufacturing apparatus 100, 500. For example, the glass manufacturing apparatus 700 can comprise the glass measurement apparatus 119a, 119b, the level communication lines 120a, 120b, the controller 115, the operator 501, the level communication line 503, etc. In some embodiments, the controller 115 may comprise a multi-variable controller that can control the level of the molten material 121 at different locations within the glass manufacturing apparatus 700. In some embodiments, the controller 115 may not be limited to receiving the predetermined level setpoint 123 and the level 609 via the level communication line 503. For example, the controller 115 can receive a flowrate setpoint 701 for the flowrate 605 of the molten material 121. In addition or in the alternative, the glass manufacturing apparatus 700 can comprise a scale 703 that measures a weight 705 of the glass ribbon 103, whereupon the controller 115 receives the weight 705 from the scale 703. In some embodiments, the scale 703 can comprise a weight gauge.

In some embodiments, the glass manufacturing apparatus 700 can comprise a temperature controller 707. The temperature controller 707 can receive a temperature setpoint 709 from the controller 115, with the temperature setpoint 709 representing a desired temperature of the molten material 121. In some embodiments, one or more temperature sensors 715a, 715b may be provided at various locations within the glass manufacturing apparatus 700 to measure a temperature of the molten material 121. For example, one temperature sensor 715a can be located at the third connecting conduit 137 between the mixing chamber 131 and the delivery vessel 133 to measure the temperature of the molten material 121 after leaving the mixing chamber 131 and before entering the delivery vessel 133. Another temperature sensor 715b can be located at the delivery pipe 139 downstream from the delivery vessel 133 to measure the temperature of the molten material 121 leaving the delivery vessel 133. While two temperature sensors 715a, 715b are illustrated in FIG. 7, it will be appreciated that additional temperature sensors can be provided at other locations. For example, an additional temperature sensor can be provided at the third connecting conduit 137, with one temperature sensor (e.g., 715a) located proximate the mixing chamber 131 to measure the temperature of the molten material 121 immediately after leaving the mixing chamber 131, and the other temperature sensor located proximate the delivery vessel 133 to measure the temperature of the molten material 121 immediately prior to entering the delivery vessel 133. In some embodiments, two temperature sensors may be provided at the delivery pipe 139. For example, one temperature sensor can be positioned at a top of the delivery pipe 139 (e.g., closer to the delivery vessel 133) while another temperature sensor can be positioned farther downstream (e.g., closer to the inlet conduit 141 of the forming vessel 140). The temperature measurements of the molten material 121 can be transmitted from the temperature sensors 715a, 715b to the temperature controller 707 via temperature communication lines 717a, 717b.

In some embodiments, one or more heating apparatus 719a, 719b may be provided at various locations within the glass manufacturing apparatus 700. The heating apparatus 719a, 719b can heat the molten material 121 to alter a flowrate of the molten material 121. For example, one heating apparatus 719a can be located proximate the temperature sensor 715a at the third connecting conduit 137 between the mixing chamber 131 and the delivery vessel 133 to heat the molten material 121 leaving the mixing chamber 131 and entering the delivery vessel 133. Another heating apparatus 719b can be located proximate the other temperature sensor 715b at the delivery pipe 139 downstream from the delivery vessel 133 to heat the molten material 121 leaving the delivery vessel 133. As with the temperature sensors 715a, 715b, while two heating apparatus 719a, 719b are illustrated in FIG. 7, it will be appreciated that additional heating apparatus 719a, 719b can be provided at other locations where temperature sensors may be provided. In some embodiments, temperature setpoints for the heating apparatus 719a, 719b can be transmitted from the temperature controller 707 to the heating apparatus 719a, 719b via heating lines 721a, 721b.

In some embodiments, methods of determining the level of the molten material 121 within the glass manufacturing apparatus 700 can comprise changing a flowrate of the molten material 121 based on the determined level of the molten material 121. For example, the level of the molten material 121 within a vessel (e.g., the mixing chamber 131 and the delivery vessel 133 in FIG. 7) can be determined by the glass measurement apparatus 119a, 119b. This level information can be transmitted to the operator 501 (e.g., via the level communication lines 120a, 120b), which can output the single level value to the controller 115 via the level communication line 503. In some embodiments, the changing the flowrate may be based on the weight of the glass ribbon 103 formed from the molten material 121. For example, the scale 703 can determine a weight of the glass ribbon 103 by weighing the glass ribbon 103. This weight can be transmitted to the controller 115 via the weight line 705. Based on the weight of the glass ribbon 103 and/or the level of the molten material 121 from the operator 501, the controller 115 can change a temperature at the heating apparatus 719a, 719b, thus changing the flowrate of the molten material 121.

In some embodiments, the changing the flowrate may comprise adjusting the temperature of the molten material 121. For example, in some embodiments, methods of manufacturing glass can comprise adjusting the temperature of the molten material 121 based on the sensed second wavelength component. As described relative to FIGS. 3-4, the sensor 341 can receive the second wavelength component 317, and the signal processor 343 can determine the level of the molten material 121 within the vessel 301 based on the sensed second wavelength component 317. The level can be transmitted to the controller 115. In some embodiments, based on the level of the mixing chamber 131 and the delivery vessel 133, it may be desired to change the flowrate of the molten material 121, for example by adjusting the temperature of the molten material 121. The controller 115 can output the desired temperature setpoint 709 for the third connecting conduit 137 and the delivery pipe 139. This temperature setpoint 709 can be transmitted to the temperature controller 707. In some embodiments, based on a comparison between the temperature of the molten material 121 sensed by the temperature sensors 715a, 715b and the desired temperature setpoint 709, the heating apparatus 719a, 719b can adjust the temperature of the molten material 121 via the heating apparatus 719a, 719b. For example, to increase the flowrate, the controller 115 can output a higher temperature setpoint 709 to the temperature controller 707, whereupon the temperature controller 707 increases the temperature generated by the heating apparatus 719a, 719b. To decrease the flowrate, the controller 115 can output a lower temperature setpoint 709 to the temperature controller 707, whereupon the temperature controller 707 decreases the temperature generated by the heating apparatus 719a, 719b.

In some embodiments, the changing the batch fill rate 603 can be based on the weight of the glass ribbon 103 formed from the molten material 121. For example, the scale 703 can measure the weight 705 of the glass ribbon 103 and transmit this weight to the controller 115. Based on the weight 705, the controller 115 can adjust the speed command to the motor 113, which can then adjust the speed of the batch delivery device 111, thus changing the batch fill rate. In some embodiments, if the weight 705 of the glass ribbon 103 is lower than desired, the controller 115 can increase the batch fill rate 603 by increasing the speed command to the motor 113. If the weight 705 of the glass ribbon 103 is higher than desired, the controller 115 can decrease the batch fill rate 603 by decreasing the speed command to the motor 113.

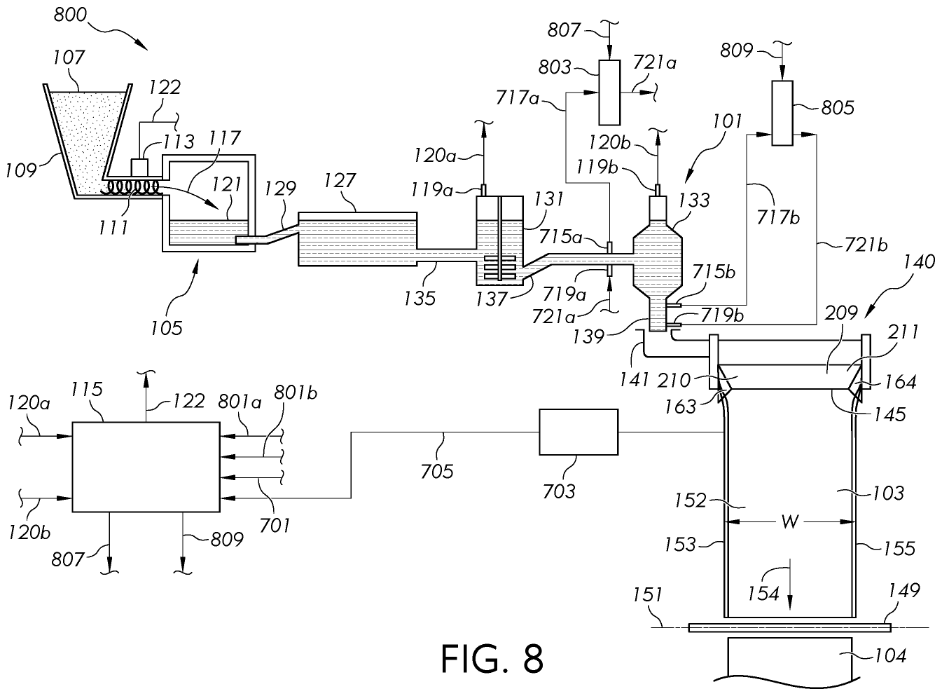

Referring to FIG. 8, further embodiments of a glass manufacturing apparatus 800 are illustrated. The glass manufacturing apparatus 800 may be similar in some respects to one or more of the glass manufacturing apparatus 100, 500, 700. For example, the glass manufacturing apparatus 800 can comprise the glass measurement apparatus 119a, 119b, the level communication lines 120a, 120b, the controller 115, the scale 703, the temperature controller 707, the temperature sensor 715a, 715b, the heating apparatus 719a, 719b, etc. In some embodiments, the glass manufacturing apparatus 800 may not comprise the operator 501, such that the glass measurement apparatus 119a, 119b transmit the level measurements directly to the controller 115 via the level communication lines 120a, 120b. The controller 115 may not be limited to receiving one predetermined level setpoint (e.g., predetermined level setpoint 123 in FIG. 7), but, rather, can receive multiple predetermined level setpoints 801a, 801b. For example, the controller can receive one predetermined level setpoint 801a corresponding to the level within the mixing chamber 131, and another predetermined level setpoint 801b corresponding to the level within the delivery vessel 133.

In some embodiments, the glass manufacturing apparatus 800 may comprise a plurality of temperature controllers for controlling the temperature of the molten material 121 at multiple locations. For example, the glass manufacturing apparatus 800 may comprise a first temperature controller 803 and a second temperature controller 805. The first temperature controller 803 can receive a first temperature setpoint 807 from the controller 115, while the second temperature controller 805 can receive a second temperature setpoint from the controller 115. In some embodiments, the first temperature controller 803 can be coupled to the temperature sensor 715a and the heating apparatus 719a. In this way, the first temperature controller 803 can receive the temperature of the molten material 121 within the third connecting conduit 137 from the temperature sensor 715a and can control the heating apparatus 719a. In some embodiments, the second temperature controller 805 can be coupled to the temperature sensor 715b and the heating apparatus 719b. In this way, the second temperature controller 805 can receive the temperature of the molten material 121 within the delivery pipe 139 from the temperature sensor 715b and can control the heating apparatus 719b.

In some embodiments, methods of determining the level of the molten material 121 within the glass manufacturing apparatus 800 can comprising changing the flowrate of the molten material 121 based on the determined level of the molten material 121. For example, the level of the molten material 121 within a vessel (e.g., the mixing chamber 131 and the delivery vessel 133 in FIG. 7) can be determined by the glass measurement apparatus 119a, 119b. This level information can be transmitted to the controller 115 via the level communication lines 120a, 120b. Changing the flowrate may not be limited to being based on the determined level of the molten material 121. Rather, in some embodiments, the changing the flowrate can be based on the weight of the glass ribbon 103 formed from the molten material 121. As described relative to FIG. 7, the scale 703 can determine the weight of the glass ribbon 103, and transmit this weight to the controller 115 via the weight line 705. Based on the weight of the glass ribbon 103 and/or the level from the operator 501, the controller 115 can change a temperature at the heating apparatus 719a, 719b, thus changing the flowrate of the molten material 121.

In some embodiments, the changing the flowrate may comprise adjusting the temperature of the molten material 121. For example, in some embodiments, depending on the level sensed by the glass measurement apparatus 119a, 119b, the controller 115 can adjust the first temperature setpoint 807 and/or the second temperature setpoint 809 provided to the first temperature controller 803 and the second temperature controller 805. If the temperature sensed by the temperature sensor 715a is different than the first temperature setpoint 807, then the first temperature controller 803 can transmit a temperature signal to the heating apparatus 719a via the heating line 721a, thus causing the heating apparatus 719a to raise or lower the temperature of the molten material 121 within the third connecting conduit 137. If the temperature sensed by the temperature sensor 715b is different than the second temperature setpoint 809, then the second temperature controller 805 can transmit a temperature signal to the heating apparatus 719b via the heating line 721b, thus causing the heating apparatus 719b to raise or lower the temperature of the molten material 121 within the delivery pipe 139. In this way, by determining the level of the molten material 121 at different locations with the glass measurement apparatus 119a, 119b, a flowrate of the molten material 121 can be changed by adjusting the temperature of the molten material 121 (e.g., at the third connecting conduit 137 and/or the delivery pipe 139).

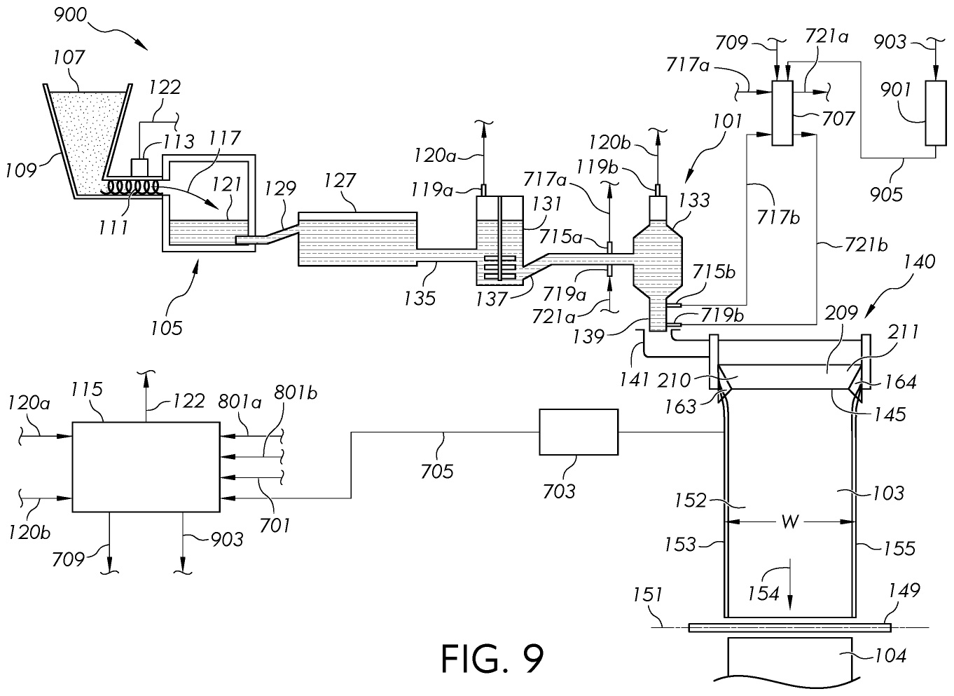

Referring to FIG. 9, further embodiments of a glass manufacturing apparatus 900 are illustrated. The glass manufacturing apparatus 900 may be similar in some respects to one or more of the glass manufacturing apparatus 100, 500, 700, 800. For example, the glass manufacturing apparatus 900 can comprise the glass measurement apparatus 119a, 119b, the level communication lines 120a, 120b, the controller 115, the operator 501, the level communication line 503, the scale 703, the temperature controller 707, the temperature sensor 715a, 715b, the heating apparatus 719a, 719b, etc.

In some embodiments, the glass manufacturing apparatus 900 can comprise a temperature ratio controller 901 to control a temperature ratio between two locations within the glass manufacturing apparatus 900. For example, the temperature ratio controller 901 can control a ratio of the temperature setpoints at the third connecting conduit 137 to the delivery pipe 139. The temperature controller 707 can receive the temperature setpoint 709 from the controller 115. The temperature ratio controller 901 can receive a ratio 903 of the temperature setpoints from the controller 115, with the ratio 903 representing a ratio 903 of a temperature setpoint at one location (e.g., the third connecting conduit 137) to a temperature setpoint at another location (e.g., the delivery pipe 139). This temperature ratio setpoint 905 can be transmitted to the temperature controller 707, which can adjust the temperatures of the heating apparatus 719a, 719b in accordance with the temperature ratio setpoint 905. For example, the controller 115 can send a temperature setpoint to the temperature controller 707. The controller 115 can also determine the desired ratio 903 of the temperature of the third connecting conduit 137 to the temperature of the delivery pipe 139. For example, if the ratio 903 is 2:1, then an amount that is twice the temperature setpoint 709 may be transmitted to the heating apparatus 719a at the third connecting conduit 137, while an amount equal to the temperature setpoint 709 may be transmitted to the heating apparatus 719b at the delivery pipe 139. Accordingly, the flowrate of the molten material 121 can be adjusted by adjusting the ratio 903 of the temperature setpoints.

In some embodiments of the disclosure, the glass manufacturing apparatus 100, 500, 700, 800, 900 may comprise the glass measurement apparatus 119a, 119b, which can measure the level of the molten material 121 in a non-contact manner without contaminating the molten material 121. The level of the molten material 121 can be measured at several locations within the glass manufacturing apparatus 100, 500, 700, 800, 900 that may not be measurable with contact level measurement apparatus. Due to the use of the non-contact glass measurement apparatus 119a, 119b in new locations, one or more parameters within the glass manufacturing apparatus 100 can be adjusted, such as batch fill rate, flowrate, etc.

Embodiments and the functional operations described herein can be implemented in digital electronic circuitry, or in computer software, firmware, or hardware, including the structures disclosed in this specification and their structural equivalents, or in combinations of one or more of them. Embodiments described herein can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine readable storage substrate, a memory device, or a combination of one or more of them.

The term “processor” or “controller” can encompass all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described herein can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit) to name a few.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), to name just a few.

Computer readable media suitable for storing computer program instructions and data include all forms data memory including nonvolatile memory, media and memory devices, including by way of exemplary semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments described herein can be implemented on a computer comprising a display device, e.g., a CRT (cathode ray tube) or LCD (liquid crystal display) monitor, and the like for displaying information to the user and a keyboard and a pointing device, e.g., a mouse or a trackball, or a touch screen by which the user can provide input to the computer. Other kinds of devices can be used to provide for interaction with a user as well; for example, input from the user can be received in any form, including acoustic, speech, or tactile input.

Embodiments described herein can be implemented in a computing system that includes a back end component, e.g., as a data server, or that includes a middleware component, e.g., an application server, or that includes a front end component, e.g., a client computer comprising a graphical user interface or a Web browser through which a user can interact with implementations of the subject matter described herein, or any combination of one or more such back end, middleware, or front end components. The components of the system can be interconnected by any form or medium of digital data communication, e.g., a communication network. Embodiments of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and comprising a client-server relationship to each other.

It is also to be understood that, as used herein the terms “the,” “a,” or “an,” mean “at least one,” and should not be limited to “only one” unless explicitly indicated to the contrary. Likewise, a “plurality” is intended to denote “more than one.”

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the appended claims. Thus, it is intended that the present disclosure cover the modifications and variations of the embodiments herein provided they come within the scope of the appended claims and their equivalents.

1. A glass manufacturing apparatus comprising:
a vessel;
a filter positioned to receive a beam of light, the filter configured to pass a second wavelength component of the beam of light through the filter while preventing a first wavelength component from the beam of light from passing through the filter; and
a sensor positioned to receive the second wavelength component that has passed through the filter and that has been reflected within the vessel.

2. The glass manufacturing apparatus of claim 1, wherein the second wavelength component comprises a wavelength that is less than a wavelength of the first wavelength component.

3. The glass manufacturing apparatus of claim 2, wherein the second wavelength component comprises a wavelength that is less than about 600 nanometers and the first wavelength component comprises a wavelength that is greater than about 600 nanometers.

4. The glass manufacturing apparatus of claim 1, further comprising molten material with a free surface positioned within the vessel.

5. The glass manufacturing apparatus of claim 4, wherein the sensor is positioned to receive the second wavelength component that has been reflected from the free surface of the molten material positioned within the vessel.

6. The glass manufacturing apparatus of claim 1, further comprising a light source positioned to emit the beam of light.

7. The glass manufacturing apparatus of claim 1, further comprising a lens configured to split the beam of light into a plurality of wavelength components comprising the first wavelength component and the second wavelength component, and wherein the filter is positioned to receive the split beam of light from the lens.

8. The glass manufacturing apparatus of claim 1, further comprising a jacket defining a jacket interior within which one or more of the filter or the sensor are positioned.

9. The glass manufacturing apparatus of claim 8, wherein the jacket is optically transparent.

10. A method of determining a level of molten material within a glass manufacturing apparatus comprising:
reflecting a beam of light comprising a second wavelength component from a free surface of a molten material;
sensing the second wavelength component from the beam of light reflected from the free surface of the molten material; and
determining the level of the molten material based on the sensed second wavelength component of the beam of light.

11. The method of claim 10, further comprising removing a first wavelength component from the beam of light prior to reflecting the beam of light comprising the second wavelength component.

12. The method of claim 11, wherein, prior to removing the first wavelength component from the beam of light, further comprising splitting the beam of light into a plurality of wavelength components comprising the first wavelength component and the second wavelength component.

13. The method of claim 11, wherein the second wavelength component comprises a wavelength that is less than a wavelength of the first wavelength component.

14. The method of claim 10, further comprising cooling a sensor that senses the second wavelength component.

15. The method of claim 10, further comprising cooling a filter that removes the first wavelength component from the beam of light.

16. The method of claim 10, further comprising changing a flowrate of the molten material based on the determined level of the molten material.

17. The method of claim 16, wherein the changing the flowrate comprises adjusting a temperature of the molten material.

18. The method of claim 16, wherein the changing the flowrate is further based on a weight of a glass ribbon formed from the molten material.

19. A method of manufacturing glass comprising:
supplying a batch material to a melting vessel at a batch fill rate;
melting the batch material into a molten material;
reflecting a beam of light comprising a second wavelength component from a free surface of the molten material;
sensing the second wavelength component from the beam of light reflected from the free surface of the molten material; and
changing the batch fill rate based on the sensed second wavelength component.

20. The method of claim 19, further comprising determining a level of the molten material based on the sensed second wavelength component.

21. The method of claim 20, wherein the changing the batch fill rate is based on the determined level of the molten material.

22. The method of claim 19, wherein the second wavelength component comprises a wavelength that is less than a wavelength of the first wavelength component.

23. The method of claim 19, further comprising cooling a sensor that senses the second wavelength component.

24. The method of claim 19, further comprising cooling a filter that removes the first wavelength component from the beam of light.

25. The method of claim 19, further comprising adjusting a temperature of the molten material based on the sensed second wavelength component.

26. The method of claim 19, wherein the changing the batch fill rate is further based on a weight of a glass ribbon formed from the molten material.
